(19) United States
(12) Patent Application Publication
(10) Pub. No.: US 2007/0283445 A1
(43) Pub. Date: Dec. 6, 2007

(54) Information processing apparatus and control method for use in the same

(76) Inventor: Taizo Kaneko, Hidaka-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/787,748

(22) Filed: Apr. 17, 2007

(30) Foreign Application Priority Data
May 31, 2006 (JP) 2006-152119

(51) Int. Cl. H04L 9/00

(52) U.S. Cl. 726/26

(57) ABSTRACT

According to one embodiment, an information processing apparatus includes a main body, a wireless communication unit provided in the main body, a memory unit which is provided in the main body and stores base station information designating a predetermined base station, a detection unit which detects a base station, which is wirelessly connectable to the wireless communication unit, in response to power-on of the main body, and a boot control unit which permits boot-up of an operating system if the base station which is detected by the detection unit agrees with the predetermined base station, and prohibits the boot-up of the operating system if the base station which is detected by the detection unit disagrees with the predetermined base station.

### CROSS-REFERENCE TO RELATED APPLICATIONS

This application is based upon and claims the benefit of priority from Japanese Patent Application No. 2006-152119, filed May 31, 2006, the entire contents of which are incorporated herein by reference.

### BACKGROUND

1. Field

One embodiment of the invention relates to an information processing apparatus such as a personal computer, which has, for example, a wireless communication function, and to a control method for use in the apparatus.

2. Description of the Related Art

In recent years, various portable personal computers of a laptop type or a notebook type have been developed. Most of these types of computer have a wireless communication function according to a wireless communication standard such as Wireless LAN.

Jpn. Pat. Appln. KOKAI Publication No. 2004-185531 discloses a data communication terminal having a wireless communication function. As regards this data communication terminal, when a user having the data communication terminal has entered a wireless LAN service area, access to a data storage unit within the data communication terminal is automatically prohibited. Thereby, data in the data storage unit is prevented from leaking to the outside via the wireless LAN.

In the meantime, recently, there has been an increasing amount of information which requires protection, such as personal information or confidential company information. Thus, in companies, work involving confidential information is done only in a specified secure area, which is established, for example, in a part of the office.

However, if a computer which stores, e.g., confidential company information is used outside the specified area, the possibility of the confidential information leaking to the outside increases.

It is thus necessary to realize a novel function which can prevent the leak of confidential information stored in the computer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the structure of an information processing apparatus according to an embodiment of the present invention;

FIG. 2 shows a first example of the system architecture of the information processing apparatus shown in FIG. 1;

FIG. 3 shows a second example of the system architecture of the information processing apparatus shown in FIG. 1;

FIG. 4 shows a third example of the system architecture of the information processing apparatus shown in FIG. 1;

FIG. 5 is an exemplary block diagram showing the system configuration of the information processing apparatus shown in FIG. 1;

FIG. 6 shows a first example of the software structure of the information processing apparatus shown in FIG. 1;

FIG. 7 shows a second example of the software structure of the information processing apparatus shown in FIG. 1;

FIG. 8 shows an example of a setup screen which is used in the information processing apparatus shown in FIG. 1;

FIG. 9 is an exemplary flowchart showing an example of the procedure of a boot security control process which is executed by the information processing apparatus shown in FIG. 1; and

FIG. 10 is an exemplary flowchart showing an example of the procedure of a device lock control process which is executed by the information processing apparatus shown in FIG. 1.

### DETAILED DESCRIPTION

Various embodiments according to the invention will be described hereinafter with reference to the accompanying drawings. In general, according to one embodiment of the invention, an information processing apparatus includes a main body, a wireless communication unit provided in the main body, a memory unit which is provided in the main body and stores base station information designating a predetermined base station, a detection unit which detects a base station, which is wirelessly connectable to the wireless communication unit, in response to power-on of the main body, and a boot control unit which permits boot-up of an operating system if the base station which is detected by the detection unit agrees with the predetermined base station, and prohibits the boot-up of the operating system if the base station which is detected by the detection unit disagrees with the predetermined base station.

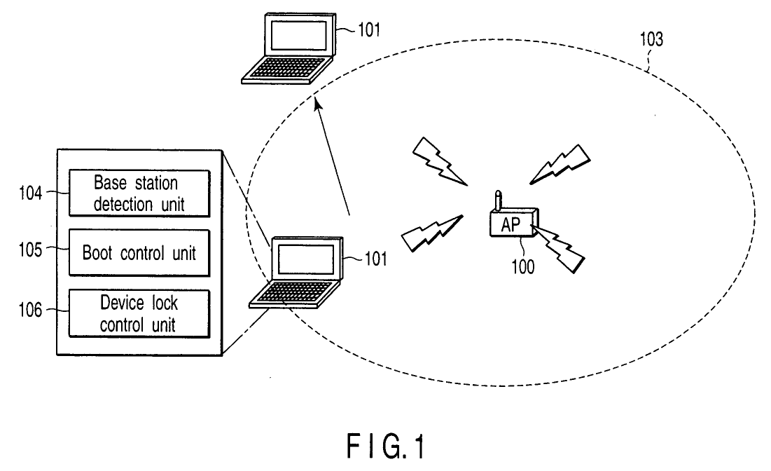

To begin with, referring to FIG. 1, a description is given of the structure of an information processing apparatus according to the embodiment of the invention. The information processing apparatus is realized as a battery-powerable notebook portable personal computer 101.

The computer 101 includes a wireless communication unit which executes wireless communication according to a wireless communication standard such as Wireless LAN. With use of the wireless communication unit, the computer 101 functions as a mobile station which is connectable to a wireless network. The computer 101 has a boot security function of determining whether the computer 101 is present within a predetermined specified area, and permitting boot-up of an operating system only when it is determined that the computer 101 is present within the specified area. Whether the computer 101 is present within the specified area is determined by using a state relating to wireless connection between a predetermined base station and the computer 101.

For example, in a specified area established in a factory site of a company or in a specified area established in an office building, a base station (hereinafter referred to as an “access point”) 100, which supports a wireless communication standard such as Wireless LAN, is disposed in advance. In this case, the position of the access point (AP) 100 is determined in advance such that a communication area 103 that is covered by the access point (AP) 100 covers a specified area. The communication area 103 has a range defined by the reach of radio signals transmitted from the access point (AP) 100. The communication area 103 has a substantially circular shape centered on the access point (AP) 100.

In the present embodiment, whether the computer 101 is present within the specified area is determined according to whether the computer 101 is present within the communication area 103 that is covered by the access point (AP) 100.

In the case where the computer 101 is present within the communication area 103 that is covered by the access point (AP) 100, the boot-up of the operating system is permitted. On the other hand, in the case where the computer 101 is present outside the communication area 103 that is covered by the access point (AP) 100, the boot-up of the operating system is prohibited.

In order to realize the above-described boot security function, the computer 101 includes a base station detection unit 104 and a boot control unit 105. The base station detection unit 104 executes, in response to power-on of the computer 101, an access point search process for detecting an access point which is wirelessly connectable to the wireless communication unit provided in the computer 101. The boot control unit 105 determines whether the access point detected by the access point search process is a predetermined specified access point (access point (AP) 100 in this example), and permits or prohibits the boot-up of the operating system in accordance with the determination result.

A memory unit provided in the computer 101 prestores base station information which designates the specified access point (access point [AP] 100 in this example). The base station information is composed of identification information for identifying the specified access point, for instance, the access point name of the specified access point, the MAC address of the specified access point, etc.

In the case where the access point which is detected by the access point search process agrees with the specified access point designated by the base station information, the boot control unit 105 permits the boot-up of the operating system. On the other hand, in the case where the access point which is detected by the access point search process disagrees with the specified access point designated by the base station information, the boot control unit 105 prohibits the boot-up of the operating system.

The computer 101 further includes a device lock control unit 106. The device lock control unit 106 executes a device lock process for prohibiting the use of an input device (e.g., keyboard, mouse, function button, etc.) provided in the computer 101, in a case where the computer 101 has been moved to outside the communication area 103 of the access point (AP) 100 after the operating system was booted. The device lock process can restrict the use of the computer 101, whose operating system has already been booted, on the outside of the communication area 103, and can prevent execution of a file operation such as copy or move of data to a removable medium.

In the device lock process, a process of turning off the display screen of a display device provided on the computer 101 is also executed. Thereby, a person is almost completely unable to use the computer 101 on the outside of the communication area 103, and confidential data is prevented from being viewed by a third person through the display screen.

Next, the operation of the computer 101, which is executed at a time of power-on, is described.

(1) When the computer 101 is powered on, the base station detection unit 104 controls the wireless communication unit, under the control of firmware such as a Basic Input/Output System (BIOS) built into the computer 101, and executes the access point search process for detecting an access point which is wirelessly connectable to the wireless communication unit. In the access point search process, an ID (e.g., access point name, MAC address, etc.) for identifying each of access points, which are wirelessly connectable to the wireless communication unit, is detected.

(2) The boot control unit 105 compares the ID (access point name, MAC address, etc.) of the detected access point with the ID (access point name, MAC address, etc.) of the specified access point indicated by the base station information prestored in the computer 101.

If the ID of the detected access point agrees with the ID of the specified access point indicated by the base station information, that is, if the detected access point agrees with the specified access point indicated by the base station information, the boot control unit 105 permits boot-up of the operating system and starts a process of booting the operating system.

On the other hand, if the ID of the detected access point disagrees with the ID of the specified access point indicated by the base station information, or if no access point has been detected by the access point search process, the boot control unit 105 displays on the display screen an error message indicating that the computer 101 is present in an area where the computer 101 cannot be used, and powers off the computer 101 after a predetermined elapsed time (e.g., several seconds).

Next, a description is given of an operation in a case where the computer 101 has been moved from within the communication area 103 to the outside of the communication area 103 after the operating system was booted.

If the computer 101, whose operating system was booted within the communication area 103, has been moved to outside the communication area 103, the device lock control unit 106 displays on the display screen a message indicating that the computer 101 has been moved to outside the specified area, and executes the device lock process. In the device lock process, the device lock control unit 106 prohibits the use of the input device (e.g., keyboard, mouse, function button, etc.), for example, by invalidating a command which is input from the input device (e.g., keyboard, mouse, function button, etc.). Further, in the device lock process, the device lock control unit 106 executes a process of turning off the display screen of the display device.

If a predetermined time has passed from the execution of the device lock process, the device lock control unit 106 executes a process of transitioning the state of the computer 101 from a working state to a standby state, thereby to prevent the context of the computer 101 from being lost due to battery power outage. The standby state is a memory suspend state in which almost all devices, excluding the main memory, are powered off, or a hibernation state in which almost all devices are powered off after the context is stored in the hard disk drive.

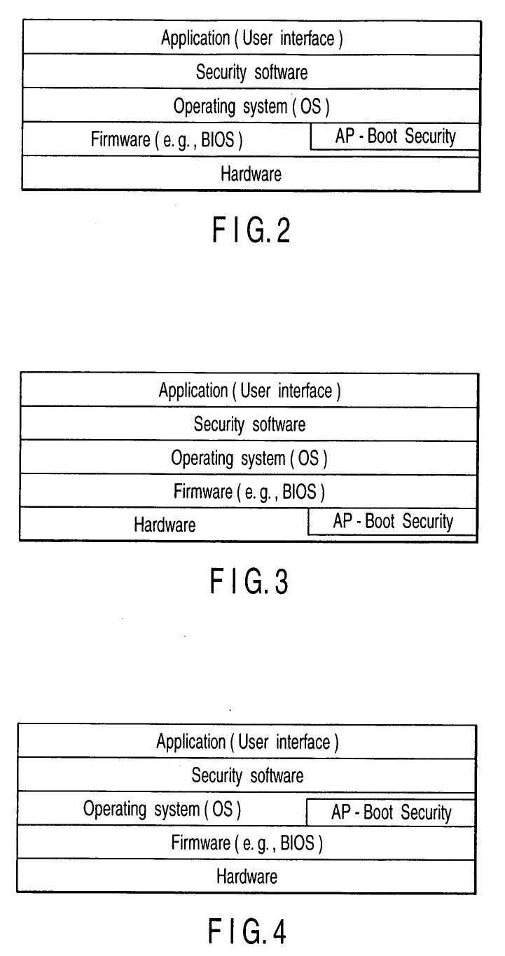

Next, referring to FIG. 2 to FIG. 4, examples of the system architecture of the computer 101 are described.

FIG. 2 shows a system architecture in a case where the above-described boot security function is realized by firmware such as the BIOS. The functions of the base station detection unit 104 and boot control unit 105 are executed by an AP-Boot Security routine which is provided in the BIOS.

FIG. 3 shows a system architecture in a case where the above-described boot security function is realized by hardware. The functions of the base station detection unit 104 and boot control unit 105 are executed by an AP-Boot Security logic which is provided in the computer 101.

FIG. 4 shows a system architecture in a case where the above-described boot security function is realized by the operating system. The functions of the base station detection unit 104 and boot control unit 105 are executed by an AP-Boot Security routine which is provided in the operating system. The AP-Boot Security routine is built in, e.g., a boot loader of the operating system.

In the description below, it is assumed that the boot security function is executed by the AP-Boot Security routine provided in the BIOS.

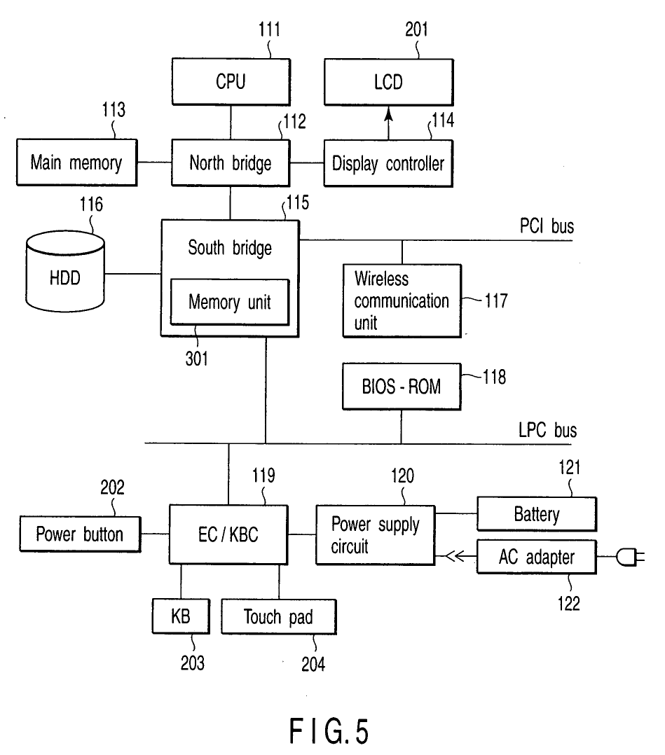

FIG. 5 shows the system configuration of the computer 101.

The computer 101 comprises a computer main body and a display unit which is attached to the computer main body. The computer main body includes a CPU 111, a north bridge 112, a main memory 113, a display controller 114, a south bridge 115, a hard disk drive (HDD) 116, a wireless communication unit 117, a flash BIOS-ROM 118, an embedded controller/keyboard controller IC (EC/KBC) 119, and a power supply circuit 120.

The CPU 111 is a processor that controls the operation of the components of the computer 101. The CPU 111 executes an operating system and various application programs/utility programs, which are loaded from the HDD 116 into the main memory 113. The CPU 111 also executes the BIOS that is stored in the flash BIOS-ROM 118. The BIOS is a program for hardware control. The BIOS includes the above-described AP-Boot Security routine for executing the boot security function.

The north bridge 112 is a bridge device that connects a local bus of the CPU 111 and the south bridge 115. In addition, the north bridge 112 has a function of executing communication with the display controller 114 via, e.g., an Accelerated Graphics Port (AGP) bus. Further, the north bridge 112 includes a memory controller that controls the main memory 113.

The display controller 114 controls an LCD 201 which is used as a display device of the computer 101. The south bridge 115 is connected to a Peripheral Component Interconnect (PCI) bus and a Low Pin Count (LPC) bus.

The south bridge 115 incorporates a memory unit 301 which is composed of, e.g., a nonvolatile memory. The memory unit 301 prestores the above-described base station information which designates the specified access point.

The wireless communication unit 117 is a wireless network device which executes wireless communication according to the IEEE 801.11 standard. The embedded controller/keyboard controller IC (EC/KBC) 119 is a single-chip microcomputer in which an embedded controller for power management and a keyboard controller for controlling a keyboard (KB) 203 and a touch pad (mouse) 204 are integrated. The keyboard (KB) 203 and touch pad (mouse) 204 are input devices and are provided, for example, on the top surface of the computer main body.

The embedded controller/keyboard controller IC 119 cooperates with the power supply circuit 120 to power on/off the computer 101 in response to the user's operation of a power button switch 202. The power supply circuit 120 generates system power, which is to be supplied to the components of the computer 101, using power from a battery 121 or external power supplied from an AC adapter 122.

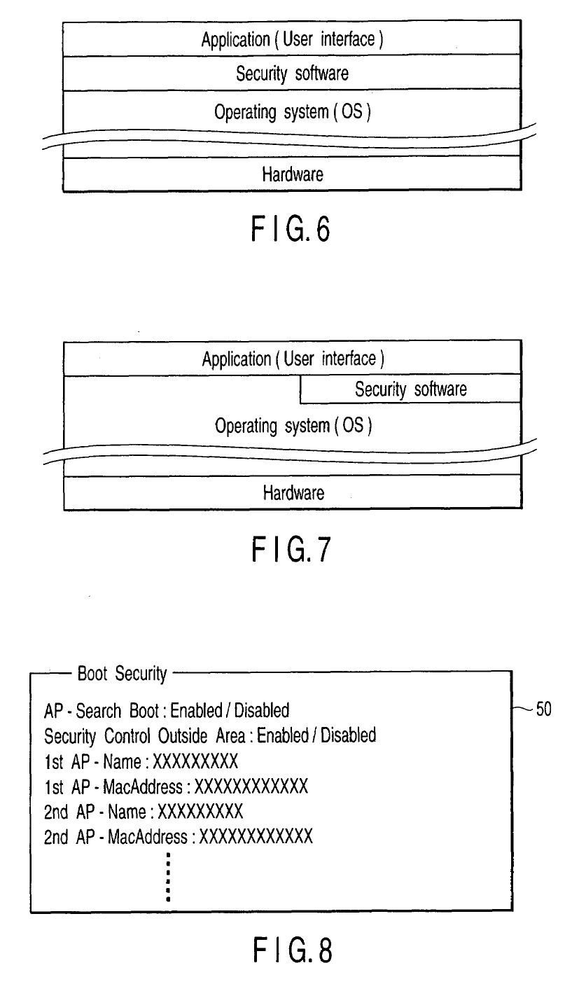

Next, referring to FIG. 6 and FIG. 7, examples of the software structure of the computer 101 are described.

FIG. 6 shows an example of the software structure in a case where the above-described device lock process is executed by dedicated software which is independent from the operating system. The function of the device lock control unit 106 is executed by security software which is dedicated software independent from the operating system.

FIG. 7 shows an example of the software structure in a case where the above-described device lock process is executed by the operating system. The function of the device lock control unit 106 is executed by security software which is built in the operating system.

FIG. 8 shows an example of a setup screen 50 for setting up the security function of the computer 101. The setup screen 50 is displayed on the LCD 201 by, e.g., the BIOS.

The setup screen 50 displays two setup items “AP-Search Boot” and “Security Control Outside Area”.

The setup item “AP-Search Boot” is a setup item for designating the enabling/disabling of the boot security function. For example, if the system administrator executes setup of “AP-Search Boot”=Enable, the boot security function is enabled. The system administrator can register one or more access points and the IDs thereof as base station information.

The setup item “Security Control Outside Area” is a setup item for designating the enabling/disabling of the device lock function. For example, if the system administrator executes setup of “Security Control Outside Area”=Enable, the device lock function is enabled.

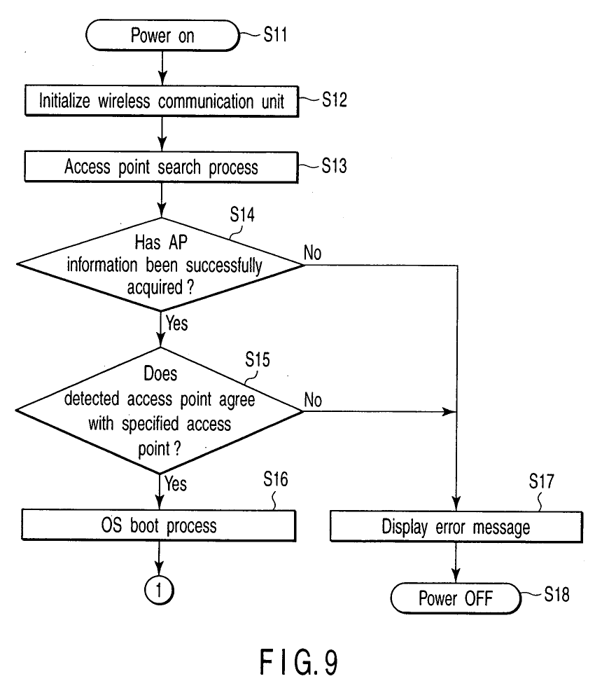

Next, referring to a flowchart of FIG. 9, a description is given of the procedure of the process which is executed by the AP-Boot Security routine of the BIOS.

If the user operates the power button switch 202, the main body of the computer 101 is powered on (block S11). Responding to the power-on of the main body, the CPU 111 executes the BIOS and carries out the following process.

The CPU 111 first initializes the wireless communication unit 117 (block S12). The CPU 111 controls the wireless communication unit 117 and executes the access point search process for detecting an access point which is wirelessly connectable to the wireless communication unit 117 (block S13). In the access point search process, the wireless communication unit 117 receives a beacon signal which is transmitted from an access point. The beacon signal includes access point information indicative of the ID of the access point. If the main body of the computer 101 is present within the communication area that is covered by a certain access point, the wireless communication unit 117 can acquire the access point information indicative of the ID of the access point.

The CPU 111 determines whether an access point, which is wirelessly connectable to the wireless communication unit 117, has been detected by the access point search process, that is, whether the access point information has been acquired (block S14).

If the access point, which is wirelessly connectable to the wireless communication unit 117, has been detected (YES in block S14), the CPU 111 compares the ID (access point name, MAC address) indicated by the acquired access point information with the ID (access point name, MAC address) indicated by the base station information stored in the memory unit 301, thereby determining whether the detected access point agrees with the specified access point that is designated by the base station information stored in the memory unit 301 (block S15).

If the detected access point agrees with the specified access point that is designated by the base station information (YES in block S15), the CPU 111 permits boot-up of the operating system and executes a process for booting the operating system (block S16).

On the other hand, if the detected access point disagrees with the specified access point that is designated by the base station information stored in the memory unit 301 (NO in block S15), or if no access point has been detected by the access point search process (NO in block S14), the CPU 111 displays an error message on the display screen of the LCD 201 (block S17) and powers off the main body of the computer 101 (block S18).

In the case where IDs corresponding to two specified access points are stored in the memory unit 301 as base station information, the boot-up of the operating system is permitted on condition that the detected access point agrees with one of the two specified access points.

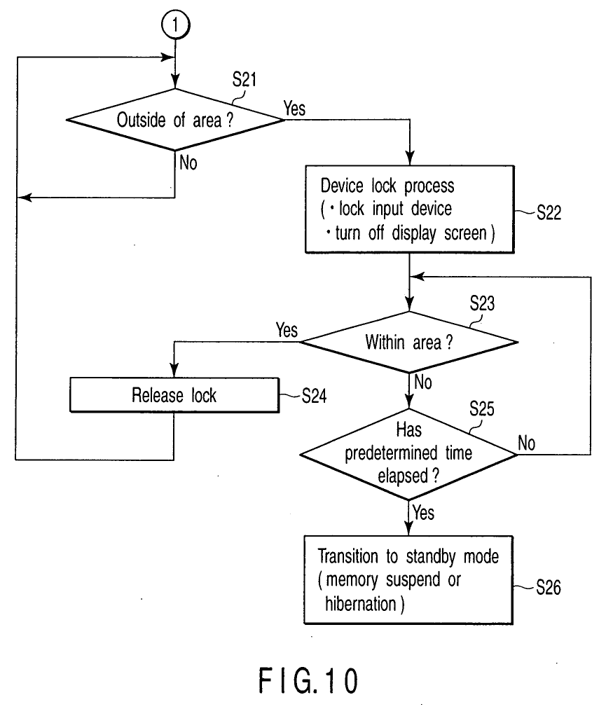

Next, referring to a flowchart of FIG. 10, the procedure of the process, which is executed by the security software, is described.

After the operating system is booted, the CPU 111 executes the following process under the control of the security software.

The CPU 111 determines whether the main body of the computer 101 has been moved to outside the communication area that is covered by the specified access point which is designated by the base station information (block S21). In block S21, for example, when the wireless connection between the specified access point designated by the base station information and the wireless communication unit 117 has been disconnected, the CPU 111 determines that the main body of the computer 101 has been moved to outside the communication area that is covered by the specified access point.

If the main body of the computer 101 has been moved the outside of the communication area that is covered by the specified access point (YES in block S21), the CPU 111 executes the device lock process in order to prevent leak of confidential information to the outside (block S22). In block S22, for example, the CPU 111 causes the keyboard controller of the EC/KBC 119 to invalidate a command and data, which are input from the input device such as the keyboard 203 or touch pad (mouse) 204, thereby prohibiting the use of the input device. In addition, in block S22, the CPU 111 turns off the display screen of the LCD 201, for example, by turning off the backlight of the LCD 201.

Thereafter, the CPU 111 determines whether the main body of the computer 101 has moved into the communication area covered by the specified access point (block S23). In block S23, the CPU 111 controls the wireless communication unit 117 and executes the access point search process, thereby determining whether the specified access point has been detected by the access point search process. If the specified access point has been detected, the CPU 111 determines that the main body of the computer 101 has moved into the communication area covered by the specified access point.

If the main body of the computer 101 has moved into the communication area covered by the specified access point (YES in block S23), the CPU 111 executes a lock release process (block S24). In block S24, the CPU 111 executes a process of permitting the use of the input device such as the keyboard 203 or touch pad (mouse) 204, and a process of turning on the display screen of the LCD 201.

On the other hand, while the main body of the computer 101 is present outside the communication area covered by the specified access point, the CPU 111 measures an elapsed time from the execution of the device lock process by using, e.g., a timer. If a predetermined time has passed since the execution of the device lock process (YES in block S25), the CPU 111 executes a process of transitioning the state of the main body of the computer 101 from the working state to the standby state (block S26). As described above, the memory suspend state or hibernation state can be used as the standby state. The memory suspend state and hibernation state correspond to system state S3 and system state S4, which are defined in the Advanced Configuration and Power Interface (ACPI) standard. In block S26, the CPU 111 executes a process of powering off the main body of the computer 101 in the state in which the main memory 113 is kept in a power-on state, thereby transitioning the computer 101 to the memory suspend state, or a process of powering off the main body of the computer 101 after storing the data, which is stored in the main memory 113, into the HDD 116, thereby transitioning the computer 101 to the hibernation state.

As has been described above, according to the present embodiment, the boot-up of the operating system is permitted only when the computer 101 is present within the predetermined specified area. It is thus possible to prevent the computer 101 from being used outside the specified area. Therefore, confidential information which is stored in the computer 101 can be prevented from leaking to the outside.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a wireless communication unit provided in the main body;
a memory unit which is provided in the main body and stores base station information designating a predetermined base station;
a detection unit which detects a base station, which is wirelessly connectable to the wireless communication unit, in response to power-on of the main body; and
a boot control unit which permits boot-up of an operating system if the base station which is detected by the detection unit agrees with the predetermined base station, and prohibits the boot-up of the operating system if the base station which is detected by the detection unit disagrees with the predetermined base station.

2. The information processing apparatus according to claim 1, further comprising:
an input device provided on the main body; and
a lock control unit which executes a device lock process of prohibiting use of the input device when the main body has been moved to outside a communication area, which is covered by the predetermined base station, after the boot-up of the operating system.

3. The information processing apparatus according to claim 2, wherein the device lock process includes a process of turning off a display screen of a display device which is provided on the main body.

4. The information processing apparatus according to claim 2, wherein the device lock unit permits the use of the input device when the main body has been moved from the outside of the communication area, which is covered by the predetermined base station, into the communication area.

5. The information processing apparatus according to claim 1, further comprising:
an input device provided on the main body;
a lock control unit which executes a device lock process of prohibiting use of the input device when the main body has been moved to outside a communication area, which is covered by the predetermined base station, after the boot-up of the operating system; and
means for transitioning a state of the main body from a working state to a standby state when a predetermined time has passed since the execution of the device lock process.

6. The information processing apparatus according to claim 1, wherein the base station information includes first information which designates the predetermined base station, and second information which designates another base station, and
the boot control unit permits the boot-up of the operating system if the base station detected by the detection unit agrees with one of the predetermined base station and said another base station.

7. A control method of controlling an operation of an information processing apparatus which executes wireless communication, comprising:
detecting a base station, which is wirelessly connectable to the information processing apparatus, in response to power-on of the information processing apparatus;
permitting boot-up of an operating system if the detected base station agrees with a predetermined base station which is designated by base station information stored in a memory unit which is provided in the information processing apparatus; and
prohibiting the boot-up of the operating system if the detected base station disagrees with the predetermined base station.

8. The control method according to claim 7, further comprising executing a device lock process of prohibiting use of an input device, which is provided on the information processing apparatus, when the information processing apparatus has been moved to outside a communication area, which is covered by the predetermined base station, after the boot-up of the operating system.

9. The control method according to claim 8, wherein the device lock process includes a process of turning off a display screen of a display device which is provided on the information processing apparatus.

10. The control method according to claim 8, further comprising permitting the use of the input device when the information processing apparatus has been moved from the outside of the communication area, which is covered by the predetermined base station, into the communication area.

11. The control method according to claim 7, further comprising:
executing a device lock process of prohibiting use of an input device, which is provided on the information processing apparatus, when the information processing apparatus has been moved to outside a communication area, which is covered by the predetermined base station, after the boot-up of the operating system; and
transitioning a state of the information processing apparatus from a working state to a standby state when a predetermined time has passed since the execution of the device lock process.

12. The control method according to claim 7, wherein the base station information includes first information which designates the predetermined base station, and second information which designates another base station, and
said permitting the boot-up of the operating system includes permitting the boot-up of the operating system if the detected base station agrees with one of the predetermined base station and said another base station.
